(19) United States
(12) Patent Application Publication
(10) Pub. No.: US 2011/0108204 A1
(43) Pub. Date: May 12, 2011

(54) RETRACTABLE COVER FOR SCREENED ENCLOSURES AND PATIOS

(76) Inventor: David A. Vogias, Fort Myers, FL (US)

(21) Appl. No.: 12/615,847

(22) Filed: Nov. 10, 2009

(51) Int. Cl. E06B 9/24; E06B 9/58

(52) U.S. Cl. 160/37; 160/38; 160/127

(57) ABSTRACT

A retractable cover (2) which may be mounted in any section (4) of a screened enclosure (1) between two rails (3) or to a patio opening (26). The retractable cover may be rolled out and opened using a pulley system (23) having pulley cables (16), pulleys (17) and/or rollers (24). The pulley system may be operated manually or automatically from fixed controls (18) or remote controls (19). Retractable shades/covers may be installed in every section of a screened enclosure or only in certain desired sections of the screened enclosure depending on a user's desire for privacy, shade and/or comfort level. In addition, a retractable cover may be installed horizontally along the length of a screened enclosure or patio opening to cover multiple sections of a screened enclosure.

This invention relates to screened enclosures for pools and patios, more particularly a retractable cover that mounts to a screened enclosure or patio opening and provides privacy and protection from sun light.

Screened enclosures surround and protect areas, such as pools, patios and lanais, by preventing the entry of insects, animals and people. Screened enclosures are constructed of rails which intersect one another to create sections that are individually covered in screen. A problem with screened enclosures is that, although the screen reduces the intensity of sun light, it does not provide enough shade to protect people from the harmful effects of the sun. Although UV protective screening is available, it is often dark and does not allow a user to choose how much sun light to allow into an enclosure. In addition, screened enclosures do not retain heat within the enclosure on cool days especially if the screened enclosure surrounds a hot tub or heated pool. Likewise, on hot days, screened enclosures do not provide enough shade to pools to help maintain the pool water at a comfortable temperature. An even further problem with screened enclosures is the lack of privacy for people inside the screened enclosure. Patios that do not have screened enclosures also have many of these same problems.

Therefore, a need exists for a retractable cover that can be mounted to a screened enclosure or a patio which provides privacy, protection from sun light and an insulating barrier on hot or cold days.

The relevant prior art includes the following references:

| Patent No. | | Issue/Publi- |
|---|---|---|
| (U.S. unless stated otherwise) | Inventor | cation Date |
| 2008/0163563 | Sciglia | Jul. 10, 2008 |
| 2007/0261316 | Reiff et al. | Nov. 15, 2007 |
| 6,708,706 | Robinson | Mar. 23, 2004 |
| 6,668,495 | Prince | Dec. 30, 2003 |
| 6,637,160 | Brooks | Oct. 28, 2003 |
| 6,604,327 | Reville | Aug. 12, 2003 |
| 2003/0014927 | Brooks | Jan. 23, 2003 |
| 6,494,246 | Blevins | Dec. 17, 2002 |
| 6,003,279 | Schneider | Dec. 21, 1999 |
| 5,740,822 | Einck | Apr. 21, 1998 |
| FR2718479 | Dominique | Oct. 13, 1995 |
| 4,683,686 | Ozdemir | Aug. 04, 1987 |
| 4,452,228 | Meyer | Jun. 05, 1984 |
| 4,051,638 | Heintz | Oct. 04, 1977 |
| 3,776,691 | Ray | Oct. 23, 1973 |
| 3,683,427 | Burkholz et al. | Aug. 15, 1972 |
| GB1,014,861 | Hafner | Dec. 31, 1965 |
| 3,009,166 | Sears | Nov. 21, 1961 |
| 2,859,756 | Barnes | Nov. 11, 1958 |
| 1,960,860 | Allen | May 29, 1934 |

### SUMMARY OF THE INVENTION

The primary object of the present invention is to provide a retractable cover that provides shade for people inside a screened enclosure or patio.

A further object of the present invention is to provide a retractable cover that protects users from the harmful effect of the sun.

Another object of the present invention is to provide a retractable cover that is an insulating barrier on hot or cold days.

An even further object of the present invention is to provide a retractable cover that provides privacy for people inside a screened enclosure or patio.

A further object of the present invention is to provide a retractable cover that is easy to extend into an open position and retract into a closed position.

Another object of the present invention is to provide a retractable cover that protects objects, such as pavers, patio furniture, pool liners, etc. from the harmful bleaching effects of the sun.

A further object of the present invention is to provide a retractable cover that acts as a wind break and reduces intrusion from rain.

An even further object of the present invention is to provide a retractable pool enclosure cover that is aesthetically pleasing.

The present invention fulfills the above and other objects by providing a retractable cover that may be mounted in any section of a screened enclosure between two rails of the screened enclosure. In addition, the retractable cover may be mounted in any patio opening. The retractable cover may be rolled out and opened using a pulley system with cables. The pulley system may be operated manually or automatically from fixed controls or a remote control. Retractable covers may be installed in every section of a screened enclosure or only in certain desired sections of the screened enclosure depending on a user's desire for privacy, shade and/or comfort level. In addition, a retractable cover may be installed so that it covers multiple sections of screened enclosure or multiple patio openings.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is front partial cutaway view of a screened enclosure having a retractable cover of the present invention mounted thereto;

FIG. 2 is a front partial cutaway view of a section of a screened enclosure having a retractable cover of the present invention mounted thereto;

FIG. 3 is a side view of a screened enclosure having tracks and guide rollers of the present invention mounted thereto;

FIG. 4 is a front view of a retractable cover of the present invention mounted in a horizontally sliding fashion to an opening of a patio; and

FIG. 5 is a front view of a retractable cover of the present invention mounted in a vertically sliding manner to an opening of a patio.

### DESCRIPTION OF THE PREFERRED EMBODIMENTS

For purposes of describing the preferred embodiment, the terminology used in reference to the numbered components in the drawings is as follows:
1. screened enclosure
2. cover
3. rails
4. section
5. screen
6. grommet
7. top edge
8. bottom edge
11. side rail
12. motor
13. guide cable attachment means
14. pipe hem
15. house
16. pulley cable
17. pulley
18. fixed control
19. remote control
22. track
23. pulley system
24. storage roller
25. patio structure
26. patio opening
27. anchor
28. guide roller

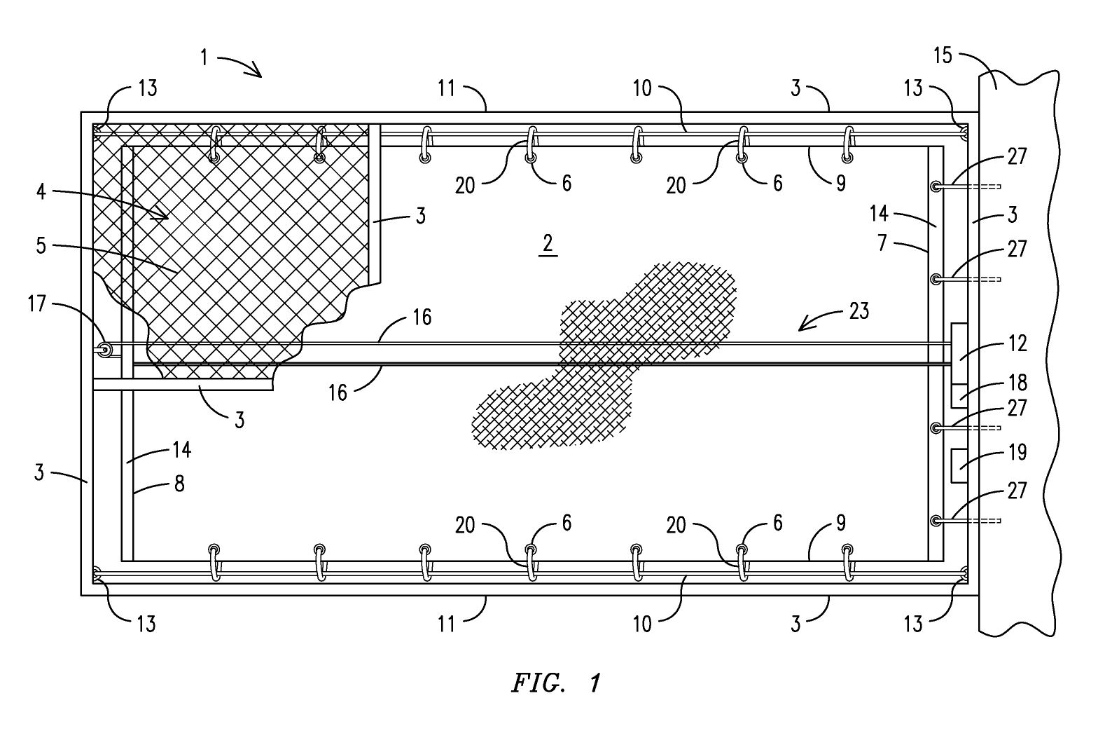

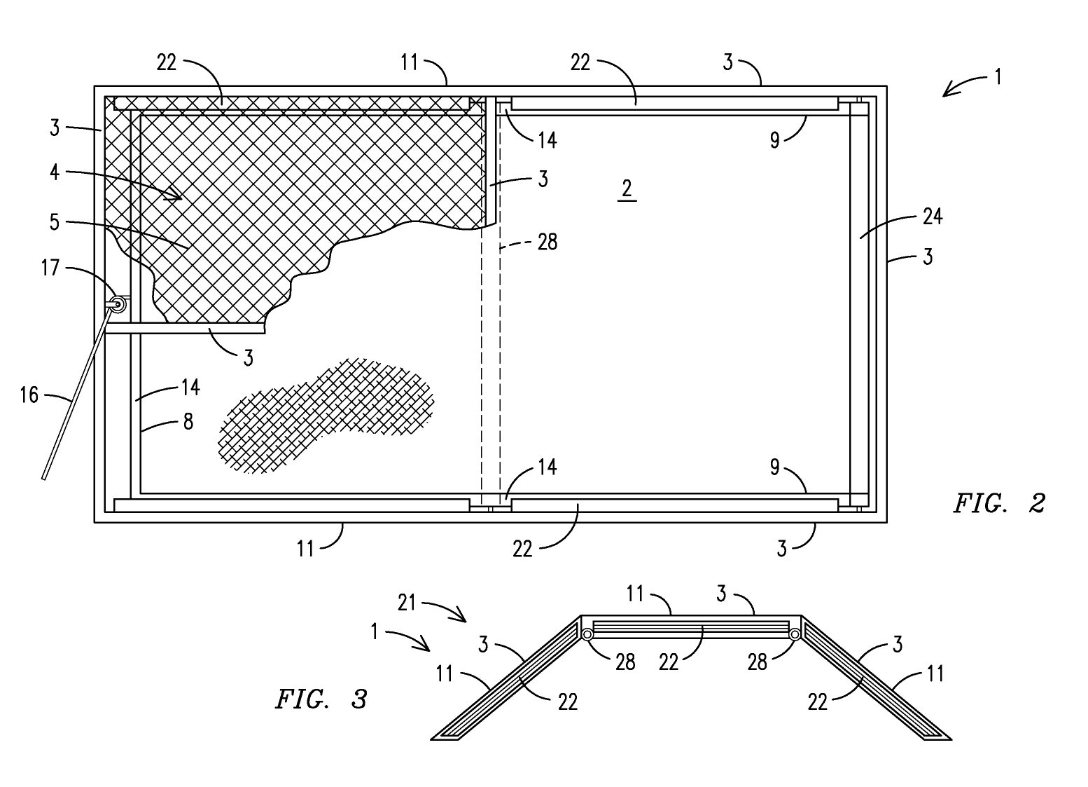

With reference to FIG. 1, a front partial cutaway view of a screened enclosure 1 having a retractable cover 2 of the present invention mounted thereto is shown. The screened enclosure 1 is constructed of rails 3 that intersect one another to create sections 4 that are individually covered in screen 5. The retractable cover 2 may be mounted in any of the sections 4 of a screened enclosure 1 between two rails 3 so that the cover 2 only covers a single section 4 or between two rails 3 so that a single cover 2 covers multiple sections 4, as shown here in FIG. 1. The retractable cover 2 is preferably made out of a lightweight U.V. resistant cloth, such as a woven polyethylene material. Grommets 6 are spaced out along the side edges 9 of the cover 2. Guide cables 10 are mounted to the screened enclosure 1 and to a house 15 by attachment means 13. The guide cables run along two side rails 11. The guide cables 10 are attached to the grommets via cable/grommet attachments 20. Pipe hems 14 along the top edge 7 and the bottom edge 8 of the shade cover 2 add rigidness to the cover 2 and also act to evenly distribute stress across the cover 2 while the cover is being opened and closed, thereby preventing uneven stretching of the cover 2. The top edge 7 of the cover 2 may be permanently attached via anchors 27 to the screen enclosure 1 or to the house 15. The bottom edge 8 of the cover 2 is attached to a pulley system 23, which comprises pulleys 17, rollers 24, as shown in FIG. 2, and pulley cables 16, used for retracting and extending the cover 2. The pulley system 23 may be operated manually by pulling the pulley cables 16 or automatically from a fixed control 18 or a wireless remote control 19, which both operate one or more motors 12 connected to the pulley cables 16.

Now referring to FIG. 2, a front partial cutaway view of a screened enclosure 1 having a retractable cover 2 of the present invention mounted thereto is shown. Rails 3 intersect one another to create sections 4 that are individually covered in screen 5. The retractable cover 2 may be mounted in any of the sections 4 of a pool enclosure between two rails 3 so that the cover 2 only covers a single section 4 or between two rails 3 so that a single cover 2 covers multiple sections 4. The retractable cover 2 shown here is attached to a storage roller 24. The storage roller 24 is pivotally attached between two side rails 11 so that the cover 2 will roll around the storage roller 24 when the cover 2 is retracted. Tracks 22 that guide the cover 2 are attached to the side rails 11. Pipe hems 14 along the side edges 9 of the cover 2 fit into the tracks 22. A guide roller 28 provides additional support for the cover 2 where the cover 2 is not being guided by tracks 22, as further illustrated in FIG. 3. A pulley cable 16 is attached to the located on a bottom edge 8 of the cover 2. A pipe hem 14 is located along the bottom edge 8 of the cover 2 to add rigidness to the cover 2. The cover 2 is retracted and extended by a pulley system 23, which comprises the pulley cables 16, rollers 24 and pulleys 17, used for retracting and extending the cover 2. The pulley system 23 may be operated manually or automatically from fixed controls 18 or a remote control 19 which both operate one or more motors 12 connected to the pulley system 23, as shown in FIG. 1.

Now referring to FIG. 3, a side view of a roof 21 of a screened enclosure 1 having tracks 22 and guide rollers 28 of the present invention mounted thereto is shown. The roof 21 screened enclosure 1 is constructed of side rails 11 that connect to one another at angles. Tracks 22 are attached to the side rails 11. Pipe hems 14 along the side edges 9 of the cover 2 fit into the tracks 22, as shown in FIG. 2. Guide rollers 28 provide additional support for the cover 2 where the side rails 11 connect to one another to form angles and the cover 2 is not being guided by tracks 22.

Now referring to FIG. 4, a front view of a retractable cover 2 of the present invention mounted in a horizontally sliding fashion to an opening 26 of a patio structure 25 is shown. Grommets 6 are spaced out along a top edge 7 and bottom edge 8 of the cover 2. Guide cables 10 are mounted via attachment means 13 along the top and bottom of the patio opening 26. The guide cables 10 are attached to the grommets 6 via cable/grommet attachments 20. Pipe hems 14 along the sides edges 9 of the cover 2 add rigidness to the cover 2. One side edge 9 of the cover 2 is permanently attached to a side of the patio opening 26 via anchors 27. The cover 2 may be opened and closed by manually pulling the cover 2 back and forth across the patio opening 26.

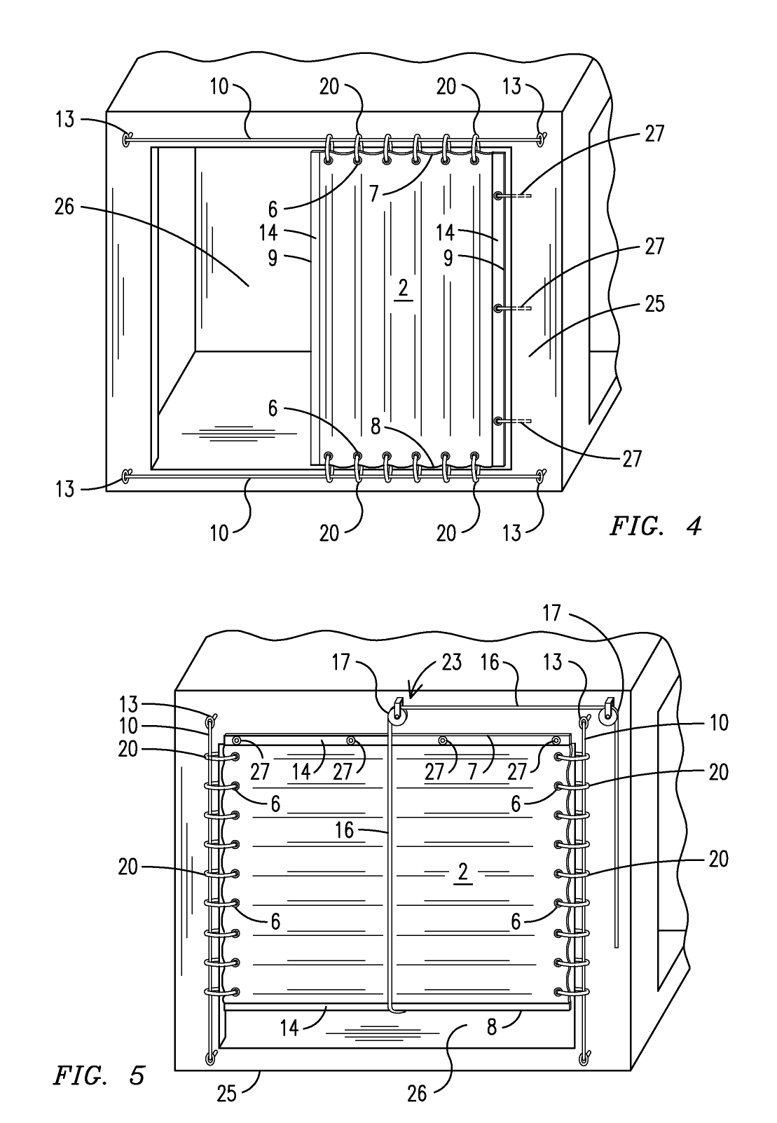

Now referring to FIG. 5, a front view of a retractable cover 2 of the present invention mounted in a vertically sliding fashion to an opening 26 of a patio 25 is shown. Grommets 6 are spaced out along side edges 9 of the cover 2. Guide cables 10 are mounted along sides of the patio opening 26. The guide cables 10 are attached to the grommets 6 via cable/grommet attachments 20. Pipe hems 14 along the top edge 7 and bottom edge 8 of the shade cover 2 add rigidness to the cover 2. The top edge 7 of the cover 2 is permanently attached to the top of the patio opening 26 via anchors 27. The bottom edge 8 of the cover 2 is attached to a pulley system 23 comprising pulleys 17, and a pulley cable 16. The pulley system 23 is used for extending and retracting the cover. The pipe hem 14 along the bottom edge 8 may have additional weight added to it in order to assist with extending the cover 2

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A retractable cover for a screened enclosure comprising:
at least one rail and at least one section of the screened enclosure;
at least one cover attached to said at least one rail; and
a means for attaching the at least one cover to said at least one rail.

2. The retractable cover for a screened enclosure of claim 1 wherein:
the means for attaching said at least one cover to said at least one rail is at least one track thereby allowing said at least one cover to slide back and forth along said at least one track.

3. The retractable cover for a screened enclosure of claim 2 further comprising:
at least one storage roller for storing the at least one roller.

4. The retractable cover for a screened enclosure of claim 2 further comprising:
at least one guide roller for supporting the at least one cover.

5. The retractable cover for a screened enclosure of claim 1 further comprising:
the means for attaching said at least one cover to said at least one rail is at least one guide cable attached to said at least one rail of said screened enclosure; and
said at least one cover is attached to said at least one guide cable via at least one grommet and at least on cable/grommet attachment thereby allowing said at least one cover to slide back and forth along said at least one guide cable.

6. The retractable cover for a screened enclosure of claim 1 further comprising:
a pulley system attached to said at least one cover for extending and retracting said at least one shade cover comprising at least one pulley and at least one pulley cable.

7. The retractable cover for a screened enclosure of claim 2 further comprising:
a pulley system attached to said at least one cover for extending and retracting said at least one shade cover comprising at least one pulley and at least one pulley cable.

8. The retractable cover for a screened enclosure of claim 5 further comprising:
a pulley system attached to said at least one cover for extending and retracting said at least one shade cover comprising at least one pulley and at least one pulley cable.

9. The retractable cover for a screened enclosure of claim 1 further comprising:
at least one motor for automatically extending and retracting said at least one cover; and
at least one fixed control for operating the at least one motor.

10. The retractable cover for a screened enclosure of claim 2further comprising:
at least one motor for automatically extending and retracting said at least one cover; and
at least one fixed control for operating the at least one motor.

11. The retractable cover for a screened enclosure of claim 5 further comprising:
at least one motor for automatically extending and retracting said at least one cover; and
at least one fixed control for operating the at least one motor.

12. The retractable cover for a screened enclosure of claim 9 further comprising:
a remote control for operating said at least one fixed control for automatically extending and retracting said at least one cover.

13. The retractable cover for a screened enclosure of claim 10 further comprising:
a remote control for operating said at least one fixed control for automatically extending and retracting said at least one cover.

14. The retractable cover for a screened enclosure of claim 11 further comprising:
a remote control for operating said at least one fixed control for automatically extending and retracting said at least one cover.

15. A retractable cover for a patio opening comprising:
at least one cover attached to said patio opening; and
a means for attaching the at least one cover to said patio opening.

16. The retractable cover for a patio opening of claim 15 wherein:
the means for attaching said at least one cover to said at least one rail is at least one track thereby allowing said at least one cover to slide back and forth along said at least one track.

17. The retractable cover for a patio opening of claim 16 further comprising:
at least one storage roller for storing the at least one roller.

18. The retractable cover for a patio opening of claim 16 wherein:
at least one guide roller for supporting the at least one cover.

19. The retractable cover for a patio opening of claim 15 wherein:
the means for attaching said at least one cover to said patio opening is at least one guide cable attached to a patio structure; and
said at least one cover is attached to said at least one guide cable via at least one grommet and at least on cable/grommet attachment thereby allowing said at least one cover to slide back and forth along said at least one guide cable.

20. The retractable cover for a patio opening of claim 15 further comprising:
a pulley system attached to said at least one cover for extending and retracting said at least one shade cover comprising at least one pulley and at least one pulley cable.

21. The retractable cover for a patio opening of claim 16 further comprising:
a pulley system attached to said at least one cover for extending and retracting said at least one shade cover comprising at least one pulley and at least one pulley cable.

22. The retractable cover for a patio opening of claim 19 further comprising:
a pulley system attached to said at least one cover for extending and retracting said at least one shade cover comprising at least one pulley and at least one pulley cable.

23. The retractable cover for a patio opening of claim 15 further comprising:
at least one motor for automatically extending and retracting said at least one cover; and
at least one fixed control for operating the at least one motor.

24. The retractable cover for a patio opening of claim 16 further comprising:
at least one motor for automatically extending and retracting said at least one cover; and
at least one fixed control for operating the at least one motor.

25. The retractable cover for a patio opening of claim 19 further comprising:
at least one motor for automatically extending and retracting said at least one cover; and
at least one fixed control for operating the at least one motor.

26. The retractable cover for a patio opening of claim 23 further comprising:
a remote control for operating said at least one fixed control for automatically extending and retracting said at least one cover.

27. The retractable cover for a patio opening of claim 24 further comprising:
a remote control for operating said at least one fixed control for automatically extending and retracting said at least one cover.

28. The retractable cover for a patio opening of claim 25 further comprising:
a remote control for operating said at least one fixed control for automatically extending and retracting said at least one cover.
